(19) United States
(12) Patent Application Publication
(10) Pub. No.: US 2024/0364219 A1
(43) Pub. Date: Oct. 31, 2024

(54) POWER CONVERTER LOOP GAIN MODULATION

(71) Applicant: TEXAS INSTRUMENTS INCORPORATED, Dallas, TX (US)

(72) Inventors: Kevin Scoones, San Jose, CA (US); Youngbok Kim, San Jose, CA (US); Orlando Lazaro, CARY, NC (US); Reza Sharifi, Sunnyvale, CA (US)

(21) Appl. No.: 18/452,175

(22) Filed: Aug. 18, 2023

Related U.S. Application Data
(60) Provisional application No. 63/462,794, filed on Apr. 28, 2023.

(51) Int. Cl. H02M 3/158; H02M 3/157

(52) U.S. Cl. CPC H02M 3/158; H02M 3/157

(57) ABSTRACT

A power converter includes a power stage circuit having a control input and an output. A pulse width modulation (PWM) controller has a control output coupled to the control input of the power stage. A compensator includes a passive component and a switch coupled to the passive component. The switch has a switch control input coupled to the control output of the PWM controller.

### CROSS-REFERENCE TO RELATED APPLICATIONS

This application claims priority to U.S. Provisional Application No. 63/462,794, filed Apr. 28, 2023, which is hereby incorporated by reference.

### BACKGROUND

For at least some types of switching power converters, the unity gain bandwidth (UGB) of the converter's control loop is a function of the duty cycle of the power converter. The duty cycle may be set to a particular value based on a function of the output voltage (Vout) from the converter and the input voltage (Vin) provided to the converter. Any given power converter is designed to operate with any input voltage within a specified range. Because the magnitude of the input voltage to a converter can vary from application to application, the duty cycle for which the converter operates can vary from application to application and thus the UGB can vary. At lower values of UGB, output voltage undershoot and overshoot upon sudden changes in load current may be larger than desired.

### SUMMARY

In one example, a power converter includes a power stage circuit having a control input and an output. A pulse width modulation (PWM) controller has a control output coupled to the control input of the power stage. A compensator includes a passive component and a switch coupled to the passive component. The switch has a switch control input coupled to the control output of the PWM controller.

### BRIEF DESCRIPTION OF THE DRAWINGS

FIG. 1 is a schematic diagram of an example boost power converter including a compensator having a duty-cycled resistor.

FIG. 2 are graphs of loop gain for different levels of duty cycle in one example.

FIG. 3 are waveforms showing output voltage transients that may occur upon changes in load current, in an example.

FIG. 4 are graphs of loop gain for different levels of duty cycle illustrating that loop gain is less sensitive to duty cycle with the example compensator of FIG. 1.

FIG. 5 is a schematic diagram of an example compensator in which a capacitor is duty-cycled.

FIG. 6 is a schematic diagram of an example Type 2 compensator in which the resistor is duty-cycled.

### DETAILED DESCRIPTION

The same reference numbers or other reference designators are used in the drawings to designate the same or similar (either by function and/or structure) features.

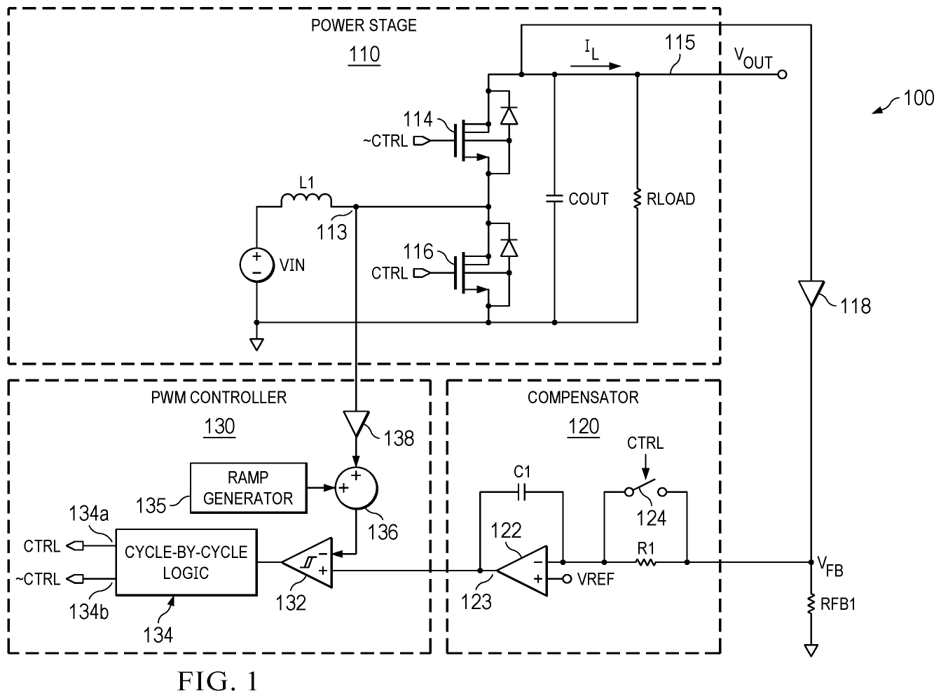

FIG. 1 is a schematic diagram of a power converter 100 having a power stage 110, a compensator 120, and a pulse width modulation (PWM) controller 130. In this example, the power converter 100 is a boost converter. However, the principles described herein can apply to other types of power converters such as buck converters, half bridge converters, etc.

The power stage 110 includes an inductor L1, transistors 114 and 116 and a capacitor C_{OUT}. Transistors 114 and 116 are n-channel field effect transistors (NFETs) in this example but can be other types of transistors in other examples. The source of transistor 114 is coupled to the drain of transistor 116. The drain of transistor 114 is coupled to the output 115 of the power converter 100 at which the output voltage V_{OUT} is produced. The source of transistor 116 is coupled to the reference terminal (e.g., ground) of the power converter. An input voltage VIN is provided to one terminal of inductor L1. A current sensor 113 is coupled between the other terminal of inductor L1 and the source of transistor 114 and drain of transistor 116. A current sensor 117 senses the load current (I_{L}) and produces an output signal (e.g., a voltage) proportional to load current. A transconductance amplifier 118 amplifies the current sensor's signal and generates an output current. A resistor R_{FB1} is coupled between the output of transconductance amplifier 118 and ground. The output current from the transconductance amplifier flows through resistor R_{FB1} and produces a feedback voltage V_{FB}.

The example compensator 120 of FIG. 1 includes an operational amplifier 122, a capacitor C1, a resistor R1, and a switch 124 (e.g., a transistor). Resistor R1 is coupled between resistor RFB1 and the negative (inverting) input of operational amplifier 122. A reference voltage VREF is provided to the positive (non-inverting) input of operational amplifier 122. Capacitor C1 is coupled between the negative input of operational amplifier 122 and the output 123 of the operational amplifier. In this configuration, the compensator is a Type 1 compensator which can also referred to as an integrator. Compensator 120 integrates the difference in the feedback voltage V_{FB} and the reference voltage V_{REF} to produce an error voltage V_{ERR} to the PWM controller. The transfer function of compensator 120 is (−1/sRC), where s is j*ω (ω is frequency in radians per second), R is the resistance of resistor R1 (ignoring the use of switch 124 coupled across resistor R1), and C is the capacitance of capacitor C1.

PWM controller 130 includes a comparator 132, cycle-by-cycle logic 134, a ramp generator 135, an adder 136, and an amplifier 138. The output of current sensor 113 is coupled to the input of amplifier 138, and the output of amplifier 138 is coupled to an input of adder 136. The ramp generator 135 produces a ramp signal at its output, which is coupled to another input of adder 136. The output of adder 136 is coupled to the negative input of comparator 132. The output 123 of operational amplifier 122 is coupled to the positive input of comparator 132. The output of comparator 132 is coupled to an input of cycle-by-cycle logic 134. The cycle-by-cycle logic 134 includes output 134a and 134b at which the cycle-by-cycle logic produces control signals CTRL and ˜CTRL, respectively. Control signal ˜CTRL is the logical inverse of control signal CTRL. In this example, output 134a is coupled to the gate of transistor 116, and output 134b is coupled to the gate of transistor 114. Gate drivers may be included to receive the control signals CTRL and ˜CTRL and produce the appropriate voltages to the gates.

In one example, the components shown in FIG. 1 are fabricated on a common semiconductor die (integrated circuit, IC). In another example, one or more of the components may be fabricated on one IC, while one or more other components are external to that IC. For example, all of the components in FIG. 1 except for inductor L1 may be fabricated on a common IC, while inductor L1 is external to that IC.

Transistors 114 and 116 are not both on simultaneously, so when transistor 116 is on, transistor 114 is off, and vice versa. PWM controller 130 implements a target duty cycle, D, for the power converter 100, which is a function of output voltage V_{OUT} and input voltage V_{IN}. In the example of a boost converter, duty cycle is proportional to (1−V_{OUT}/V_{IN}). In the example of a buck converter, duty cycle is proportional to V_{OUT}/V_{IN}. The duty cycle refers to the percentage of time of each switching cycle that transistor 116 is on. For example, for a 50% duty cycle (D=0.5), transistors 114 and 116 are on for the same amount of time during each switching cycle. For a 75% duty cycle (D=0.75), transistor 116 is on for 75% of each switching cycle and transistor 114 is on for 25% of each switching cycle.

The power stage 110, compensator 120, and PWM controller 130 form a control loop. The loop gain of the control loop of power converter 100 can be represented mathematically as:

$$loop gain = \frac{α * ( 1 - D )}{sRC} \qquad ( Eq . 1 )$$

where α includes one or more parameters of the control loop (irrelevant to the principles described herein) and R is the resistance of resistor R1 ignoring the effect of switch 124 coupled across resistor R1. Loop gain thus is a function of (1−D) and frequency.

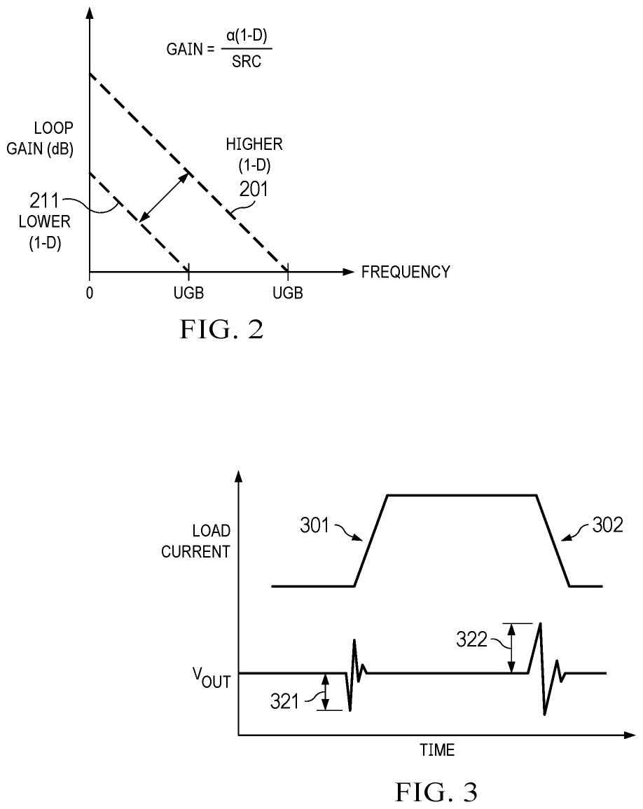

FIG. 2 is a graph of loop gain versus frequency in which switch 124 across resistor R1 within compensator 120 is assumed not to be present. A loop gain of 0 dB is a gain of 1 (i.e., unity gain). Two graphs 201 and 211 are shown in FIG. 2. For both graphs, loop gain decreases as frequency increases. The frequency at which loop gain is 0 dB (unity gain) is referred to as the unity gain bandwidth (UGB). Because loop gain is, among other things, a function of (1−D) per Eq. 1 above, graph 201 is for a loop gain at a lower duty cycle (that is, a larger value of (1−D)) than for graph 211. As described above, duty cycle D is a function of V_{OUT} and V_{IN}, and thus (1−D) may be lower in some applications (graph 211) than for other applications (e.g., graph 201). The value of UGB for graph 211 is smaller than for graph 201. That is, an application whose duty cycle is such that (1−D) is smaller will have a smaller UGB than for an application whose duty cycle is such that (1−D) is larger. A lower value of UGB may undesirably result in a larger transient response.

FIG. 3 are graphs of load current and output voltage V_{OUT} versus time. Load current in this example has two transients 301 and 302. At 301, load current increases rapidly from a lower level to higher level, and at 302, load current rapidly decreases back to the lower level. The control loop of power converter 100 responds to the changes in load current so as to maintain the output voltage VOUT at its target level. However, because the UGB for the power converter may be at a low enough level (e.g., graph 211) that unfortunately the rapid increase in load current (301) results in relatively large output voltage droop 321, and the rapid decrease in load current (302) unfortunately results in a relatively large output voltage overshot 322.

Assuming switch 124 is present and coupled across resistor R1 as is shown in FIG. 1, switch 124 is opened and closed in response to control signal CTRL. Control signal ˜CTRL turns on and off transistor 114 within the power stage 110 in accordance with (1−D) of the converter, and control signal CTRL turns on and off transistor 116 in accordance with the duty cycle D. Switch 124 also is opened (disabled) and closed (enabled) based on control signal CTRL. Accordingly, switch 124 is controlled to be closed/enabled in accordance with D. Resistor R1 is shorted when switch 124 is closed, and resistor R1 is not shorted when switch 124 is opened. By controlling switch 124 using control signal CTRL, the resistor R1 is duty-cycled in accordance with (1-D). That is, resistor R1 is present (not shorted) in compensator 120 for a time period of (1-D) of each switching cycle, and thus the equivalent resistance resulting from duty-cycling resistor R1 is a resistance equal to (1−D)*R, where R is the resistance of resistor R1.

By duty cycling resistor R1 based on (1−D), the transfer function for compensator 120 is

$$( - \frac{1}{s ( 1 - D ) RC} ) ,$$

and thus the loop gain becomes:

$$loop gain = \frac{α * ( 1 - D )}{s ( 1 - D ) RC} \qquad ( Eq . 2 )$$

The (1−D) value that the compensator now includes as part of its transfer function cancels the (1−D) value that is inherently present in the loop gain per Eq. 1 above. By duty cycling the resistor R1 within compensator 120, the converter's loop gain becomes substantially insensitive to duty cycle D, or (1−D). The other parameters that effect loop gain (α, R, C) can be set to result in a fairly large value of UGB thereby decreasing the magnitude of the undershoot and overshoot that otherwise would occur absent duty cycling the resistor within the compensator 120.

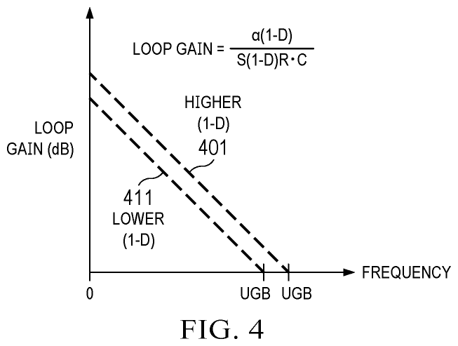

FIG. 4 is a graph of loop gain for the power converter 100 of FIG. 1 in which the compensator 120 includes a switch that duty cycles the resistor to produce an equivalent resistance equal to (1−D)*R to thereby render the loop gain largely insensitive to duty cycle, as described above. Two graphs 401 and 411 are shown in FIG. 4. Graph 401 represents loop gain for a higher level of (1−D) while graph 411 represents loop gain for a lower level of (1−D). The two values of D, and thus (1−D) in FIG. 4 may be the same as for FIG. 2. The two graphs 401 and 411 are closer together than in FIG. 2, and thus the values of UGB are closer together as well.

Referring again to FIG. 1, both resistor R1 and capacitor C1 are passive components. In the example of FIG. 1, absent switch 124, the transfer function of compensator 120 is inversely proportional to both the resistance (R) of resistor R1 and the capacitance (C) of capacitor C1 as described above regarding Eq. (1). In FIG. 1, passive component R1 is duty-cycled as described above.

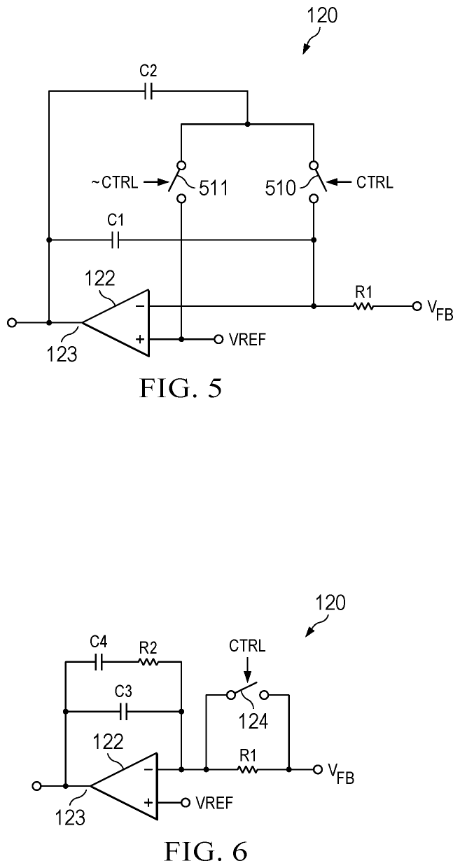

FIG. 5 is a circuit schematic of compensator 120 in which capacitor C1 is duty-cycled instead of resistor R1. Capacitor C1 is coupled between the negative input of operational amplifier 122 and output 123, as described above. A second capacitor C2 has a terminal coupled to output 123 and another terminal coupled to terminals of switches 510 and 511. The other terminal of switch 510 is coupled to the negative input of operational amplifier 122. The other terminal of switch 511 is coupled to the positive input of operational amplifier 122 and receives voltage VREF. Control signal CTRL controls the on/off state of switch 510, and its logical inverse (˜CTRL) controls the on/off state of switch 511. When switch 510 is off/open and switch 510 is on/closed, capacitor C2 is not electrically coupled in parallel with capacitor C1, and instead receives voltage VREF. When switch 510 is on/closed and switch 511 is off/open, capacitors C1 and C2 are electrically coupled in parallel and present an equivalent capacitance (C1+C2) for the transfer function of the compensator. The time-averaged equivalent capacitance of the compensator thus is C1 (C1+C2)/[C1+C2(1−D)], which at least partially offsets the loop gain's dependence on (1−D) as described above. When C1<<C2, then the time-average equivalent capacitance is C1/(1−D), which better offsets the loop gain's dependence on (1−D).

FIG. 6 is a schematic diagram of compensator 120 in accordance with another example. The example compensator 120 in FIG. 6 is a Type 2 compensator. Compensator 120 in FIG. 6 includes the operational amplifier 122, resistor R1, and switch 124 coupled across resistor R1. The feedback of operational amplifier 122 also includes a capacitor C4 coupled in series with a resistor R2. In this example, resistor R1 is duty-cycled as described above based on control signal CTRL.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

As used herein, the terms “terminal”, “node”, “interconnection”, “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuitry. For example, a field effect transistor (“FET”) (such as an n-channel FET (NFET) or a p-channel FET (PFET)), a bipolar junction transistor (BJT—e.g., NPN transistor or PNP transistor), an insulated gate bipolar transistor (IGBT), and/or a junction field effect transistor (JFET) may be used in place of or in conjunction with the devices described herein. The transistors may be depletion mode devices, drain-extended devices, enhancement mode devices, natural transistors or other types of device structure transistors. Furthermore, the devices may be implemented in/over a silicon substrate (Si), a silicon carbide substrate (SiC), a gallium nitride substrate (GaN) or a gallium arsenide substrate (GaAs).

References may be made in the claims to a transistor's control input and its current terminals. In the context of a FET, the control input is the gate, and the current terminals are the drain and source. In the context of a BJT, the control input is the base, and the current terminals are the collector and emitter.

References herein to a FET being “on” or “enabled” means that the conduction channel of the FET is present and drain current may flow through the FET. References herein to a FET being “off” or “disabled” means that the conduction channel is not present so drain current does not flow through the FET. An “off” FET, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description.

Modifications are possible in the described embodiments, and other embodiments are possible, within the scope of the claims.

What is claimed is:

1. A power converter, comprising:
a power stage circuit having a control input and an output;
a pulse width modulation (PWM) controller having a control output coupled to the control input of the power stage circuit; and
a compensator including a passive component and a switch coupled to the passive component, the switch having a switch control input coupled to the control output of the PWM controller.

2. The power converter of claim 1, wherein the passive component is a resistor.

3. The power converter of claim 2, wherein the switch is coupled in parallel with the resistor.

4. The power converter of claim 2, wherein the compensator includes an operational amplifier having an amplifier input, and the resistor is coupled between the output of the power stage circuit and the amplifier input.

5. The power converter of claim 4, wherein the switch is coupled in parallel with the resistor.

6. The power converter of claim 1, wherein the passive component is a capacitor.

7. The power converter of claim 6, wherein the compensator includes an operational amplifier having an amplifier input and an amplifier output, and the capacitor is coupled between the amplifier input and the amplifier output.

8. The power converter of claim 7, wherein the capacitor is a first capacitor, and the compensator includes a second capacitor having first and second capacitor terminals, the first capacitor terminal is coupled to the amplifier output, and the switch is coupled to the second capacitor.

9. The power converter of claim 1, wherein the PWM controller has an input, and the compensator has an output coupled to the input of the PWM controller.

10. A power converter, comprising:
a power stage circuit having a control input and an output;
a pulse width modulation (PWM) controller having an input and a control output, the control output coupled to the control input of the power stage circuit; and
a compensator having an input and an output, the input of the compensator coupled to the output of the power stage circuit, and the output of the compensator coupled to the input of the PWM controller, the compensator having a transfer function that is inversely proportional to a duty cycle of the PWM controller.

11. The power converter of claim 10, wherein the compensator comprises:
an operational amplifier having an input and an output coupled to the output of the compensator;
a resistor coupled between the output of the power stage circuit and the input of the operational amplifier;
a capacitor coupled between the input of the operational amplifier and the output of the operational amplifier; and
a switch having a switch control input, the switch coupled to at least one of the resistor or the capacitor, the switch control input coupled to the control output of the PWM controller.

12. The power converter of claim 11, wherein the switch is coupled in parallel with the resistor.

13. The power converter of claim 11, wherein the capacitor is a first capacitor, and the compensator includes a second capacitor coupled between the input of the operational amplifier and the output of the operational amplifier, and the switch has a first switch terminal coupled to the first capacitor and a second switch terminal coupled to the second capacitor.

14. The power converter of claim 10, the transfer function is inversely proportional to a square of the duty cycle of the PWM controller.

15. An integrated circuit (IC), comprising:
a transistor having a control input;
a pulse width modulation (PWM) controller has a PWM input and a control output coupled to the control input of transistor; and
an operational amplifier having an input and an output, the output of the operational amplifier coupled to the PWM input;
a passive component coupled to the input of the operational amplifier; and
a switch coupled to the passive component, the switch having a switch control input coupled to the control output of the PWM controller.

16. The IC of claim 15, wherein the switch coupled in parallel with the passive component.

17. The IC of claim 15, wherein the passive component is a capacitor.

18. The IC of claim 15, wherein the passive component is a capacitor.

19. The IC of claim 18, wherein the capacitor is a first capacitor, and the IC comprises a second capacitor coupled between the input of the operational amplifier and the output of the operational amplifier, and the switch is coupled between the first and second capacitors.

20. The IC of claim 15, wherein the transistor is a first transistor, the control input is a first control input, the control output is a first control output, and the PWM controller has a second control output, and the IC comprises a second transistor having a second control input coupled to the second control output, and the switch control input is coupled to at least one of the first control output or the second control output.
